(19) United States
(12) Patent Application Publication
(10) Pub. No.: US 2026/0355971 A1
(43) Pub. Date: Nov. 12, 2026

(54) INFORMATION PROCESSING DEVICE, INPUT DEVICE, ARTICLE MANUFACTURING METHOD, INFORMATION PROCESSING METHOD, AND RECORDING MEDIUM

(71) Applicant: CANON KABUSHIKI KAISHA, Tokyo (JP)

(72) Inventor: HIROFUMI ONISHI, Kanagawa (JP)

(21) Appl. No.: 19/666,573

(22) Filed: May 4, 2026

(30) Foreign Application Priority Data
May 7, 2025 (JP) 2025-077256

(51) Int. Cl. B25J 9/16; G06T 3/40; G06T 3/60; G06T 7/73; G06T 11/00

(52) U.S. Cl. CPC B25J 9/1697; B25J 9/1687; G06T 3/40; G06T 3/60; G06T 7/73; G06T 11/00; G06T 2200/24

(57) ABSTRACT

An information processing device includes a communication portion configured to communicate with a control device, and a processing unit. The control device is configured to control an operation of a movable unit by using an image that is capturable by an imaging device. The processing unit is configured to acquire, from the control device, a first image corresponding to an image captured by the imaging device in a state in which the movable unit is at a first position in a case where the control device moves the movable unit from the first position to a second position, acquire information regarding movement in a case where the movable unit moves from the first position to the second position, and generate a second image corresponding to an image that is capturable by the imaging device at the second position based on the first image and the information regarding the movement.

### BACKGROUND

### Field of the Technology

The present disclosure relates to an information processing device and the like capable of communicating with a control device that controls an operation of a movable unit by using an image captured by an imaging device.

### Description of the Related Art

Robots are being introduced in various fields including production sites. As one method for controlling a position and a pose of a robot, visual servoing in which a change in position of a target is measured as visual information, and the visual information is used as feedback information, is known. Specifically, a target image captured at a target position or pose and a current image captured at a current position or pose are acquired for a target object, and the robot is controlled based on a difference therebetween. There is no need to perform strict calibration in advance, and there is an advantage that alignment can be performed based on a captured image even in a case where an error occurs in an actual operation of the robot with respect to a command value.

JP 2011-136377 A describes a method in which a robot and a robot controller are communicably connected to each other, and the robot controller controls an operation of the robot by visual servoing. The robot controller is connected to an image processing device that acquires an image from a camera mounted on the robot, and can transmit an operation command to the robot.

Here, for example, a teaching pendant including an input unit and a display unit is generally connected to a control device that controls the robot. If an image captured by an imaging device can be displayed on the display unit of the teaching pendant without a delay time when operation control of the robot is performed using the captured image, it is convenient because a user can grasp the progress of the operation control in real time while viewing a screen at hand.

However, in general, a communication mechanism connecting a robot control unit and an operation panel such as a teaching pendant to each other does not provide a communication rate high enough to transmit a captured image from the robot control unit to the operation panel without delay. For example, in a case where the robot control unit performs control based on a captured image at a control cycle of 500 Hz, calculation of a robot control amount based on the captured image is performed within 2 ms. On the other hand, for example, when it is attempted to transmit a captured image having a data size of 1.2MB per image (frame) from the robot control unit to the operation panel via the Ethernet (registered trademark), it takes about 10 ms to transmit one image. Therefore, even when attempting to display the captured image used for control on a display unit of the operation panel, a display screen cannot be updated at the original frame rate of the captured image, and a delay occurs, as a result of which the user cannot smoothly and immediately grasp a change in position and pose of the robot. In addition, in a case where the data size of the image to be transmitted to the operation panel is reduced according to the communication rate, if the frame rate is not changed, the resolution of the image is reduced. If the resolution of the display image is not changed, the display frame rate is lowered, and thus, a smooth moving image is not obtained. Therefore, the user cannot accurately grasp the progress status of the control based on the captured image.

### SUMMARY

One of the problems to be solved by the embodiments disclosed in the present specification and the drawings is that a technology useful for displaying an image with which a user grasps a progress status of control based on a captured image was not provided. However, the problems to be solved by the embodiments disclosed in the present specification and the drawings are not limited to the above problem. A problem corresponding to each effect achieved by each configuration described in the embodiments described below can also be regarded as another problem.

According to a first aspect of the present disclosure, an information processing device includes a communication portion configured to communicate with a control device, and a processing unit. The control device is configured to control an operation of a movable unit by using an image capturable by an imaging device. In a case where the control device moves the movable unit from a first position to a second position, the processing unit is configured to: acquire, from the control device, a first image corresponding to an image that is capturable by the imaging device in a state in which the movable unit is at the first position, acquire information regarding movement while the movable unit moves from the first position to the second position, and generate, based on the first image and the information regarding the movement, a second image corresponding to an image that is capturable by the imaging device in a state in which the movable unit is at the second position.

According to a second aspect of the present disclosure, an information processing method using an information processing device configured to communicate with a control device includes acquiring, by the information processing device, a first image from the control device, the first image corresponding to an image that is capturable by the imaging device in a state in which the movable unit is at the first position, acquiring, by the information processing device, from the control device, information regarding movement while the movable unit moves from the first position to the second position, and generating, based on the first image and the information regarding the movement and by the information processing device, a second image corresponding to an image that is capturable by the imaging device in a state in which the movable unit is at the second position. The control device is configured to control an operation of the movable unit on which the imaging device is mounted by using an image that is capturable by the imaging device

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of a robot apparatus including an information processing device according to an embodiment.

FIG. 2 is a schematic block diagram illustrating a configuration of a control system of the robot apparatus.

FIG. 3 is a view illustrating an example of a user interface screen displayed on a display screen of an input device.

FIG. 4 is a flowchart illustrating a procedure of information processing performed by the input device.

FIG. 5 is a flowchart illustrating a visual servoing control procedure performed by a control device.

FIG. 6 is a flowchart illustrating in detail a procedure when the input device performs step S14 and step S15.

FIG. 7 is a flowchart illustrating in detail a procedure when the control device performs step S23 and step S24 until visual servoing is completed.

FIG. 8 is a diagram illustrating an image displayed on an image display section of the input device according to a first embodiment at each stage of the visual servoing.

FIG. 9 is a diagram illustrating an image displayed on an image display section of an input device according to a second embodiment at each stage of visual servoing.

FIG. 10 is a flowchart illustrating in detail a procedure when a control device according to a third embodiment performs step S23 and step S24.

FIG. 11 is a flowchart illustrating in detail a procedure when an input device according to the third embodiment performs step S14 and step S15.

FIG. 12 is a diagram illustrating an image displayed on an image display section of the input device according to the third embodiment at each stage of visual servoing.

FIG. 13 is a diagram illustrating an image displayed on an image display section of an input device according to a fourth embodiment at each stage of visual servoing.

### DESCRIPTION OF THE EMBODIMENTS

A robot apparatus including an information processing device according to an embodiment, an information processing method, and the like will be described with reference to the drawings. The embodiments described below are merely examples, and for example, detailed configurations can be appropriately changed and implemented by those skilled in the art without departing from the gist of the idea for solving the problem.

In the drawings referred to in the following embodiments and description, elements denoted by the same reference numerals have similar functions unless otherwise specified. In the drawings, in a case where a plurality of the same elements are arranged, reference numeral and a description thereof may be omitted.

In addition, the drawings may be schematic for convenience of illustration and description, and thus, the shape, size, arrangement, and the like of elements in the drawings may not strictly match those of actual ones.

### First Embodiment

### Overall Configuration

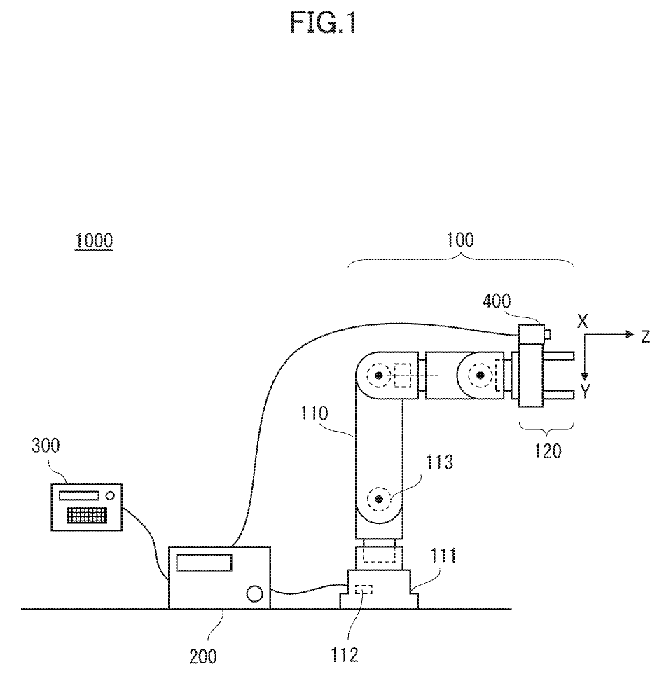

FIG. 1 is a schematic diagram illustrating a configuration of a robot apparatus including an information processing device according to an embodiment. As illustrated in FIG. 1, a robot apparatus 1000 includes a robot 100 serving as a movable unit, a control device 200 that controls an operation of the robot 100, and an input device 300 serving as an information processing device.

The robot 100 as the movable unit includes a robot arm and a robot hand 120 mounted on a distal end of the robot arm. The robot arm is formed by coupling a plurality of links 110 by a plurality of joints 113, and a proximal end side of the robot arm is fixed to a floor by a base 111. In this example, the robot 100 includes a vertically articulated robot arm, and the robot hand 120 serving as an end effector is mounted on the distal end. However, the robot 100 may be a robot of another type. The robot 100 may be of various types such as a vertically articulated type, a parallel link type, and a linear joint type. The apparatus including the movable unit may be an apparatus that is not referred to as a robot, and may be, for example, an apparatus including a movable unit capable of performing an operation of expansion and contraction, bending and stretching, vertical movement, horizontal movement, or turning, or a combined operation thereof.

The robot 100 includes a robot control unit 112 and an imaging device 400, which are communicably connected to the control device 200 in a wired or wireless manner. The robot 100 is, for example, an industrial robot, and is used for work of manufacturing an article in a manufacturing line, for example. The work of manufacturing an article can be, for example, work of causing the robot hand 120 to hold a first workpiece and operating the robot arm to assemble the first workpiece to a second workpiece. In addition, the work performed by the robot 100 to manufacture an article may be processing work, conveyance work, assembling work, or coating work. Examples of the processing work can include cutting work, grinding work, polishing work, and sealing work. The work performed by the robot 100 may be work of machining a workpiece by operating a tool using the robot hand 120. An end effector mounted on the robot arm is not limited to the robot hand 120, and an end effector corresponding to the work can be mounted.

The robot 100 includes the robot control unit 112 that controls operations of each joint 113 and the robot hand 120. The robot control unit 112 is configured to be able to communicate with the control device 200, and controls a driving unit (for example, a motor) of each joint 113 and the robot hand 120 based on a command value transmitted from the control device 200. The robot control unit 112 is disposed inside the base 111, for example. A position where the robot control unit 112 is disposed is not limited to the inside of the base 111, and may be disposed at another position. In some cases, the robot control unit 112 may be disposed inside a housing of the control device 200, for example. That is, the robot control unit 112 may be configured as a part of the control device 200.

The imaging device 400 used for performing visual servoing is mounted on the robot hand 120 or in the vicinity of the distal end of the robot arm. The imaging device 400 is mounted at a position where a target (workpiece) that is a work target can be imaged when the robot 100 performs work by the visual servoing. The imaging device 400 is, for example, a digital camera capable of capturing a two-dimensional image, and may be, for example, a three-dimensional camera. Image data captured by the imaging device 400 is transmitted to the control device 200.

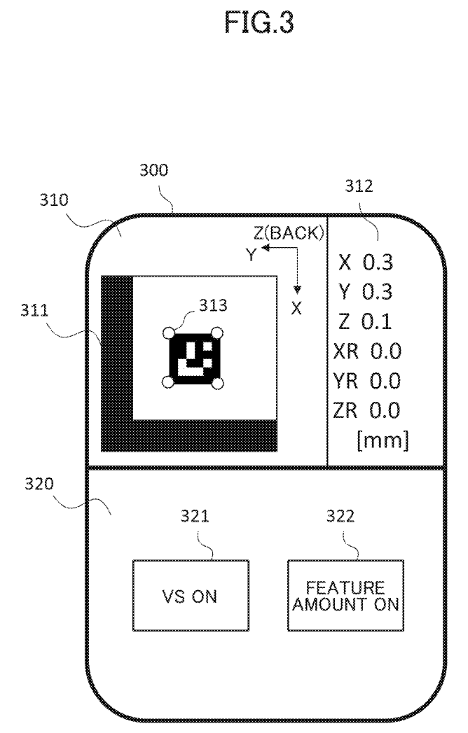

The control device 200 is a computer that controls the entire operation of the robot apparatus 1000. The control device 200 is not only communicably connected to the robot control unit 112 and the imaging device 400 as described above, but also communicably connected to the input device 300. Although FIG. 1 illustrates a wired communication mechanism, all or part of the communication mechanism may be a wireless communication mechanism. The input device 300 is described below with reference to FIG. 3 and the like.

### Control System

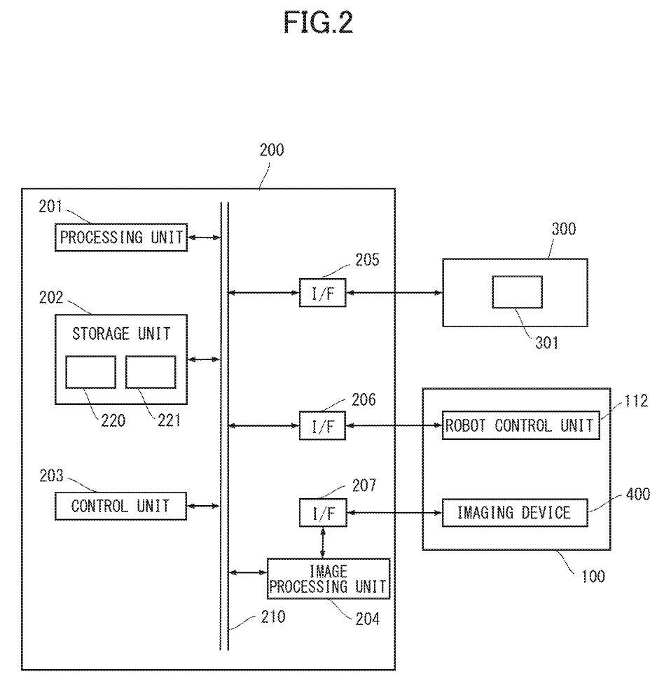

FIG. 2 is a schematic block diagram illustrating a configuration of a control system of the robot apparatus 1000. The control device 200 is a device that controls the operation of the robot 100, and is a computer including, as hardware, a central processing unit (CPU), various storage devices such as a random access memory (RAM), a read only memory (ROM), a hard disk drive (HDD), and a solid state drive (SSD), an interface such as an I/O port, a dedicated circuit such as an application-specific integrated circuit (ASIC), and the like. By including a graphics processing unit (GPU) or a GPU memory (VRAM), a hardware configuration capable of high-speed processing may be provided. Furthermore, the control device 200 can be configured by connecting a plurality of computers via a network. The hardware elements included in the control device 200 are connected via a bus 210 so as to be able to perform data communication.

FIG. 2 does not fully illustrate the hardware configuration of the control device 200, but schematically illustrates functions of the control device 200 as functional blocks. In FIG. 2, functional elements necessary for describing characteristics of the present embodiment are represented by functional blocks, but a description of general functional elements not directly related to the principle for solving the problems is omitted. In addition, each functional element illustrated in FIG. 2 is functionally conceptual, and does not necessarily have to be physically configured as illustrated. For example, a specific form of distribution or integration of the respective functional blocks is not limited to the illustrated example, and all or some of the functional blocks can be functionally or physically distributed and integrated in arbitrary units according to a use situation or the like.

The control device 200 includes functional blocks of a processing unit 201, a control unit 203, and an image processing unit 204. The functional blocks can be implemented by a CPU or a GPU reading and executing a program stored in a computer-readable recording medium included in the storage unit 202. Some of the functional blocks may be implemented by dedicated hardware such as an ASIC.

The control device 200 includes the storage unit 202, and for example, a reference image 220 (target image) used for the visual servoing and a robot program 221 for performing the visual servoing are recorded. The storage unit 202 stores and reads various types of setting information (imaging device setting, a feature point extraction parameter, a robot control program, and the like), a control log of the robot, the target image described below, a current image, feature point information, and the like, which are referred to when the control device 200 performs visual servoing control. In addition, the storage unit 202 can function as a work area when various types of computations are performed. The storage unit 202 can be implemented by, for example, a non-volatile memory such as an HDD, an optical disk, a magneto-optical disk, a magnetic tape, or a USB memory, a RAM, or a device such as an SSD, a flash memory, or a network storage.

In addition, the control device 200 includes an interface (I/F) 205, an (I/F) 206, and an (I/F) 207, which function as input/output interfaces (I/O ports). The control device 200 is capable of bidirectional information communication with the input device 300 via the (I/F) 205, bidirectional information communication with the robot control unit 112 via the (I/F) 206, and bidirectional information communication with the imaging device 400 via the (I/F) 207.

The processing unit 201 performs computation processing for performing a visual servoing operation included in the robot program 221. The processing unit 201 acquires angle information of each joint 113 of the robot arm and position information of the imaging device 400 from the robot control unit 112 via the (I/F) 206 and the bus 210. The processing unit 201 calculates a robot control amount for bringing the robot 100 closer to a target position and a target pose based on the acquired information, and transmits the robot control amount to the control unit 203 via the bus 210.

The control unit 203 acquires the robot control amount from the processing unit 201, converts the robot control amount into a command value corresponding to each joint of the robot arm and the robot hand, and outputs the converted command value to the robot control unit 112 via the bus 210 and the (I/F) 206.

The control device 200 acquires captured image data from the imaging device 400 via the (I/F) 207. As described below, the control device 200 acquires an initial image from the imaging device 400 via the (I/F) 207 at the start of the visual servoing, and transmits the acquired initial image to the input device 300 via the (I/F) 205. The input device 300 includes a storage unit 301, and can store information including the initial image received from the control device 200.

The initial image captured by the imaging device at the start of the visual servo, or an image that is capturable by the imaging device at the start of the visual servo, may be referred to as a first image. In this specification, "captured image" may refer to either a captured image by the imaging device or a simulated image that is correspond to the image capturable by the imaging device, and these may be rephrased as "image capturable by the imaging device".

The image processing unit 204 performs image processing on the captured image acquired from the imaging device 400 and extracts a feature element. The feature element is obtained by extracting, for example, a side or a corner as a characteristic element from an object image included in an image. Coordinates for specifying a position of the extracted feature element are treated as an image feature amount (feature amount information). The image processing unit 204 calculates a reference image feature amount (target image feature amount) based on the reference image (target image). In addition, an initial image feature amount is calculated based on the initial image. In addition, a current image feature amount is calculated based on the latest captured image (current image). The image feature amount (feature amount information) calculated by the image processing unit 204 is transmitted to the input device 300 via the bus 210 and the (I/F) 205. As described below, the control device 200 performs robot control processing by the visual servoing using the reference image feature amount (target image feature amount) and the current image feature amount.

### Input Device Serving as Information Processing Device

The input device 300 is, for example, an information terminal to which a user inputs information regarding an operation of the robot 100, and may be, for example, a teaching pendant, a tablet terminal with a touch panel, an operation panel, or the like. The input device 300 includes a display unit, and can display an image to be referred to by the user for inputting the information regarding the operation of the robot 100, and information and an image regarding a state of the robot 100 acquired from the control device 200. The input device 300 is an information processing device that receives information input by the user, such as a command related to control of the robot 100, transmits the information to the control device 200, processes information received from the control device 200, and displays the information on the display unit.

The input device 300 includes a display screen having a touch input function, a control unit (computer), a communication mechanism for communicating with the control device 200, the storage unit 301 that stores information acquired from the control device 200, and the like.

FIG. 3 is a view illustrating a user interface screen displayed on the display screen of the input device 300. The display screen has the touch input function, but in a case where a display-only device having no touch input function is used, an input unit such as a switch, a keyboard, a mouse, a jog dial, or a joystick may be provided separately from the display screen.

A display unit 310 that displays the information and the image regarding the state of the robot 100 is disposed at an upper portion of the user interface screen, and an operation unit 320 that displays a button or the like with which the user can input an operation command is disposed at a lower portion in the screen. The display unit 310 includes an image display section 311 that displays information regarding the progress of the visual servoing, and a movement amount display section 312 that displays information regarding a movement amount of the imaging device 400.

The image display section 311 can display the initial image captured by the imaging device 400 at the start of the visual servoing, a simulated image generated by the input device 300 by simulating the captured image of the imaging device 400 during the visual servoing, and a final image captured by the imaging device 400 at the completion of the visual servoing. In addition to such images, information regarding a current orientation of a coordinate system of the imaging device 400 is displayed on the image display section 311. The simulated image may be referred to as a second image. The final image may be referred to as a third image.

The movement amount display section 312 displays cumulative movement amounts of the imaging device 400 in an X-axis direction, a Y-axis direction, and a Z-axis direction and cumulative rotation amounts of the imaging device 400 around an X axis, a Y axis, and a Z axis (each axis is fixed) thereafter with the position of the imaging device 400 at the start of the visual servoing as a reference. Information displayed on the movement amount display section 312 is not limited to the cumulative movement amounts of the imaging device 400, and may be a movement amount of a certain portion of the robot 100.

In the example illustrated in FIG. 3, the cumulative movement amounts of the imaging device 400 illustrated in the movement amount display section 312 are 0.3 mm in the X-axis direction, 0.3 mm in the Y-axis direction, and 0.1 mm in the Z-axis direction in the coordinate system of the imaging device 400.

At this time, the image display section 311 displays the simulated image generated by simulating an image captured at the current position by the imaging device based on the initial image acquired from the imaging device 400 at the start of the visual servoing and the cumulative movement amounts described above.

The initial image is translated by an amount obtained by converting a movement amount in a direction opposite to the imaging device 400 into an image coordinate system based on an XY plane. Then, a display area of the initial image is maintained, and an image obtained by enlarging the target is displayed. Assuming that a focal length is f (mm) and a distance between the imaging device 400 and the target is z (mm), translational movement amounts on the image coordinate system are -0.3f/z (mm) in the X-axis direction and -0.3f/z (mm) in the Y-axis direction. A magnification ratio of the image is z/(z - 0.1) (times). Since the simulated image is generated by translating the initial image on the XY plane, a region which is outside an imaging region of the initial image and in which no image data exists appears on a screen of the image display section 311. In the example of FIG. 3, a region in the simulated image where imaging data (valid image data) does not exist is displayed in black. A region where the imaging data (valid image data) is not reflected in the simulated image is not limited to being displayed in black, and may be displayed in other colors, or may be displayed in a specific texture that can be visually recognized by the user, such as hatching or dots.

In the operation unit 320, a switch 321 for instructing start of the visual servoing and a switch 322 for switching whether or not to display the feature amount on the image display section 311 are disposed. The switches 321 and 322 are not limited to switches having forms and functions described below, and may be toggle switches, for example.

When the user touches the switch 321, the switch 321 receives an input of a visual servoing execution instruction, and the visual servoing execution instruction is transmitted from the input device 300 to the control device 200. In the control device 200 that has received the visual servoing execution instruction, the visual servoing execution command is transmitted to the processing unit 201 via the (I/F) 205 and the bus 210.

When the visual servoing execution instruction is received from the user, the input device 300 performs display indicating that the visual servoing is being performed, for example, by turning on the switch 321. When the control device 200 notifies that the visual servoing has ended, the input device 300 performs switching to a display indicating that the visual servoing is not being performed, for example, by turning off the switch 321.

The switch 322 is a switch that switches whether or not to display the position (feature amount information) of the feature element on the image display section 311, and is, for example, a switch that switches between ON and OFF every time the user touches the switch 322. When the switch 322 is in an ON state, a feature amount image 313 indicating the feature amount information is displayed on the image display section 311, and when the switch is in an OFF state, the feature amount image 313 is not displayed on the image display section 311. The feature amount information is coordinates representing a position such as a side or a corner extracted as the characteristic element (feature element) from an image of the target included in the image. FIG. 3 is an example in which X coordinates and Y coordinates of four vertexes of the target (marker) are used as the feature amount information, and the feature amount image 313 generated with circular marks is combined with the simulated image and displayed on the image display section 311.

### Control Procedure/Information Processing Method

Next, a procedure of an information processing method in which the control device 200 operates the robot 100 by the visual servoing after the user instructs the start of the visual servoing via the input device 300, and the input device 300 processes and displays information regarding the progress of the visual servoing will be described.

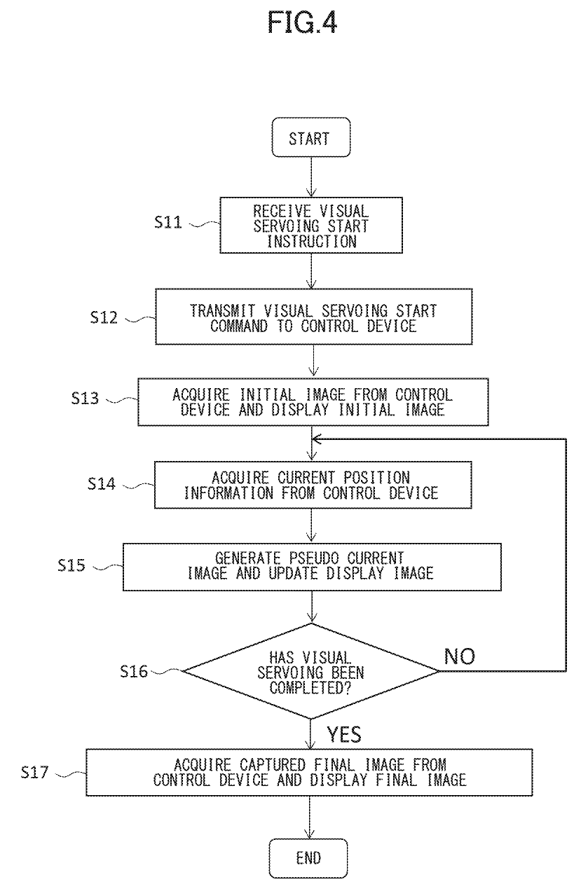

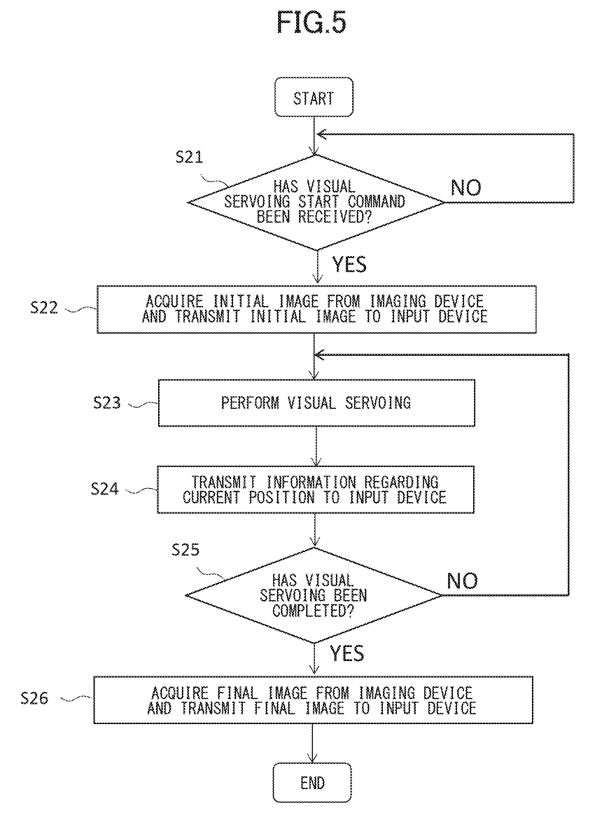

FIG. 4 is a flowchart illustrating a procedure of information processing performed by the input device 300, and FIG. 5 is a flowchart illustrating a visual servoing control procedure performed by the control device 200.

In step S11 of FIG. 4, when the user presses the switch 321 of the input device 300, the control unit of the input device 300 receives an input of the visual servoing start instruction from the user. In step S12, the control unit of the input device 300 transmits a visual servoing start command to the control device 200.

As in step S21 of FIG. 5, the control device 200 waits for the visual servoing start command to be transmitted from the input device 300, and when the visual servoing start command is received (step S21: YES), the control device 200 proceeds to step S22.

In step S22, the control device 200 acquires the captured image from the imaging device 400 via the (I/F) 207. The image is a captured image at a visual servoing start time point, and is referred to as the “initial image” for convenience. The control device 200 transmits the initial image acquired from the imaging device 400 to the input device 300. More specifically, in addition to the initial image, the control device 200 transmits an internal parameter of the imaging device 400 (camera) and an initial feature amount to the input device 300. For example, information regarding a focal length of a lens is transmitted as the internal parameter of the imaging device 400 (camera). The initial feature amount is three-dimensional position information of a feature element (for example, a side or a corner) of an object image extracted from the initial image. It can also be said that the initial feature amount is information indicating where the feature element is as viewed from the imaging device 400 when the robot 100 is at an initial position (first position). The initial feature amount can also be calculated using a position (x,y) of the feature element on the initial image, a distance (z) from the imaging device to the feature element on the object, and the internal parameter of the imaging device 400 (camera).

When the control device 200 transmits the initial image to the input device 300 in step S22, the input device 300 receives the initial image, stores the initial image in the storage unit 301 (FIG. 2), and displays the initial image on the image display section 311 in step S13 in FIG. 4. At this time, the movement amount is displayed as 0 on the movement amount display section 312 to indicate that the robot 100 is at the initial position. The user can easily check the state of the robot 100 at the start of the visual servoing by viewing the initial image on the display screen. At a time point when the visual servoing control is started, the image transmitted from the control device 200 to the input device 300 is only the initial image, and thus a problem of a communication speed does not occur.

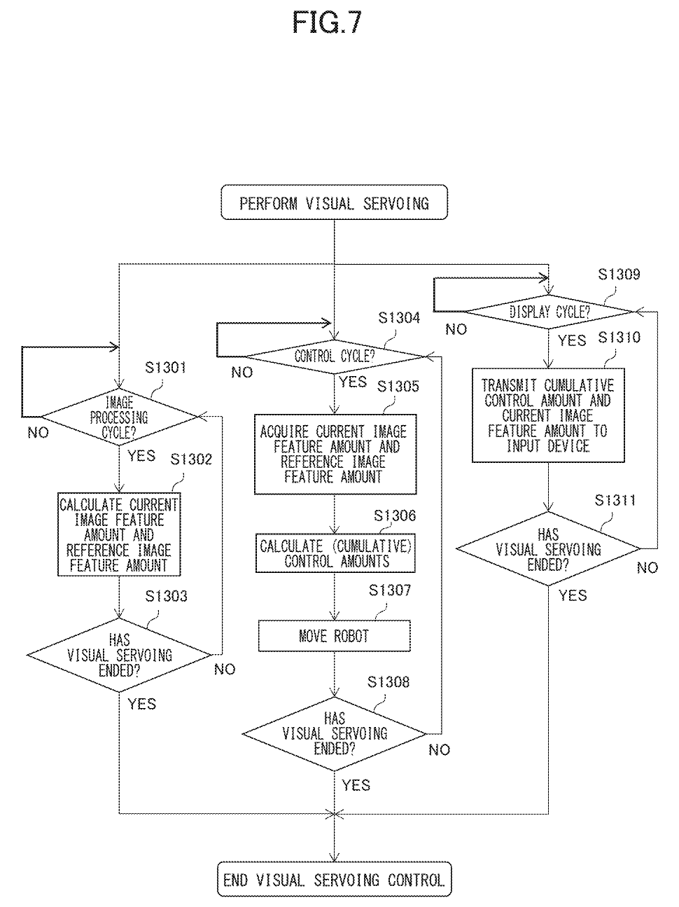

Returning to FIG. 5, the control device 200 proceeds to step S23 subsequent to step S22, and controls the operation of the robot 100 by the visual servoing. When the visual servoing is started, the control device 200 repeats steps S23 and S24 until the visual servoing is completed (that is, until a result of step S25 becomes YES). The processing of step S23 and step S24 will be described in detail with reference to FIG. 7.

FIG. 7 is a flowchart illustrating in detail a procedure when the control device 200 performs step S23 and step S24 until the visual servoing is completed. Until the visual servoing is completed, the control device 200 performs in parallel three steps of processing including image processing for the captured image, robot control processing using an image processing result, and transmission processing for information regarding the current position to the input device 300. The three steps of processing are repeatedly performed in parallel until the visual servoing is completed, but a repetition cycle is different for each step of processing.

The image processing performed by the control device 200 is processing in which the image processing unit 204 repeatedly extracts (calculates) the image feature amount until the visual servoing ends, as illustrated in a path on the left side of FIG. 7 (steps S1301 to S1303). The image processing is repeatedly performed at a predetermined cycle (for example, 30 ms which is a display update cycle of the input device) as indicated in step S1301.

When the image processing is performed, in step S1302, the image processing unit 204 reads the reference image 220 (target image) stored in advance from the storage unit 202, and calculates the reference image feature amount from the reference image 220. The reference image 220 (target image) is an image captured by the imaging device 400 with the robot 100 disposed at the target position and the target pose in advance. The target position and the target pose may be collectively referred to as a second position. Furthermore, the image processing unit 204 calculates the current image feature amount from the current image captured by the imaging device 400. A calculation result of the image processing unit 204 is used in the transmission processing for the information regarding the current position (step S1310).

The robot control processing performed by the control device 200 is processing in which the control unit 203 transmits a control command to the robot control unit 112 to operate the robot such that the robot approaches the target position and the target pose as illustrated in the central path (steps S1304 to S1308) in FIG. 7. As indicated in step S1304, the control unit 203 determines whether or not a timing corresponding to a predetermined control cycle (for example, 2 ms) has been reached in step S1304 until the visual servoing ends (until a result of step S1308 becomes YES). The robot control processing in and after step S1305 is performed at the timing corresponding to the predetermined control cycle (step S1304: YES).

When the robot control processing is performed, in step S1305, the processing unit 201 causes the image processing unit 204 to calculate the current image feature amount and acquires the current image feature amount together with the reference image feature amount.

Next, in step S1306, the processing unit 201 acquires the angle information of each joint 113 of the robot 100 and the position information of the imaging device 400 from the robot control unit 112 via the (I/F) 206 and the bus 210.

The processing unit 201 calculates the robot control amount for bringing the robot 100 closer to the target position and the target pose based on the acquired information, and transmits the robot control amount to the control unit 203 via the bus 210. The robot control amount can be calculated by a known method using the current image feature amount, the reference image feature amount, and a pseudo inverse matrix of the image Jacobian. Furthermore, the processing unit 201 calculates a cumulative value of the robot control amount after starting the visual servoing, in other words, information regarding cumulative movement amounts of the robot 100 moved from the initial position (first position). Since the imaging device 400 is integrated with the robot 100, the cumulative movement amounts of the robot 100 may be rephrased as the cumulative movement amounts of the imaging device 400 in the following description. The information regarding the cumulative movement amounts is used in the transmission processing for the information regarding the current position (step S1310).

In step S1307, the control unit 203 converts the robot control amount acquired from the processing unit 201 into command values corresponding to each joint 113 of the robot arm and the robot hand 120. The command values can be calculated by a known method using an inverse matrix of the robot Jacobian. Then, the command values are output to the robot control unit 112 via the bus 210 and the (I/F) 206. The robot control unit 112 controls the operations of each joint 113 and the robot hand 120 based on the received command values. That is, the robot moves so as to approach the target position and the target pose.

The transmission processing for the information regarding the current position to the input device 300, which is performed by the control device 200, is processing of transmitting the information regarding the current position of the robot 100 to the input device 300 until the visual servoing ends (until a result of step S1311 becomes YES) as illustrated in a path on the right side of FIG. 7 (steps S1309 to S1311). As indicated in step S1309, the processing is repeatedly performed at a predetermined cycle, that is, a cycle (for example, 30 ms) in which the input device 300 updates a display image.

In step S1310, the current image feature amount calculated in step S1302 and the cumulative movement amounts of the robot 100 calculated in step S1306 are transmitted as the information regarding the current position of the robot 100 from the control device 200 to the input device 300 via the (I/F) 205. The information regarding the current position of the robot 100 transmitted here may be rephrased as information regarding the current position of the imaging device 400. For example, (dX, dY, dZ, dωX, dωY, and dωZ) may be transmitted as data indicating accumulation of the translational movement amounts of the imaging device 400 in three axis directions and rotational movement amounts of the imaging device 400 around three axes from the initial position.

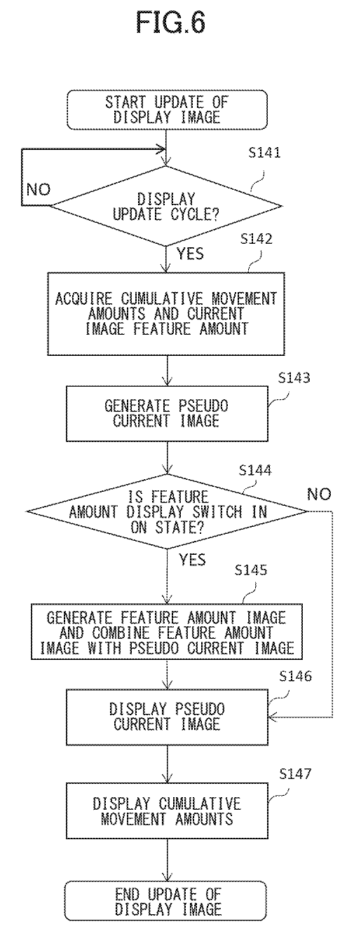

Returning to FIG. 4, while the control device 200 performs the visual servoing (step S16: NO), the input device 300 repeatedly performs steps S14 and S15, and updates a display content displayed on the display screen at a predetermined cycle (for example, 30 ms). The processing of step S14 and step S15 will be described in detail with reference to FIG. 6.

FIG. 6 is a flowchart illustrating in detail a procedure when the input device 300 performs step S14 and step S15. In step S141, the control unit of the input device 300 waits for a timing to update the display content. When the timing to update the display content has arrived (step S141: YES), the control unit of the input device 300 proceeds to step S142 and acquires the latest information regarding the current position of the robot 100 transmitted from the control device 200. That is, the current image feature amount and the cumulative movement amounts of the robot 100 are acquired.

In subsequent step S143, the control unit of the input device 300 generates the simulated image that simulates an image captured by the imaging device 400 at the current position of the robot 100. In the following description, the latest simulated image to be generated may be referred to as a pseudo current image.

First, a three-dimensional position of the feature point of the target based on the current position of the imaging device 400 is obtained from the initial feature amount and the cumulative movement amounts. Then, two-dimensional position coordinates (x’,y’) of the feature point on the image in a case where the imaging device 400 images the target from the current position are obtained by perspective transformation. Instead of obtaining the two-dimensional position coordinates of the feature point, the current image feature amount (x’,y’) received from the control device 200 may be used.

Then, a geometric transformation matrix for transforming the initial position feature amount (x,y), which is the position of the feature element on the initial image, into the two-dimensional position coordinates (x’,y’) or the current image feature amount (x’,y’) described above is obtained. The geometric transformation matrix is, for example, an affine transformation matrix or a homography transformation matrix. Such a geometric transformation matrix is applied to each pixel of the initial image acquired in step S22 (FIG. 5) to generate the pseudo current image.

In subsequent step S144, the control unit of the input device 300 determines whether or not the switch 322 described with reference to FIG. 3 is in the ON state. When the switch 322 is in the OFF state (step S144: NO), the processing proceeds to step S146, and the control unit of the input device 300 displays the pseudo current image generated in step S143 on the image display section 311. When the switch 322 is in the ON state (step S144: YES), the processing proceeds to step S145, and the control unit of the input device 300 generates the feature amount image based on the current image feature amount acquired in step S142 and combines the generated feature amount image with the pseudo current image generated in step S143. Then, the processing proceeds to step S146, and the pseudo current image combined with the feature amount image is displayed on the image display section 311. FIG. 3 illustrates an example in which the pseudo current image combined with the feature amount image 313 is displayed on the image display section 311.

Next, the processing proceeds to step S147, and the control unit of the input device 300 displays information regarding the cumulative movement amounts from the initial position of the robot 100 (or the imaging device 400) on the movement amount display section 312 (FIG. 3) based on the cumulative movement amounts acquired in step S142.

The display image is updated as described above, thus the cumulative movement amounts and the current image feature amount calculated by the control device 200 are transmitted from the control device 200 to the input device 300 instead of current image data having a large information amount and captured by the imaging device 400. Since the cumulative movement amounts and the current image feature amount are smaller in information amount than the current image data, even if a speed of communication between the control device 200 and the input device 300 is low, the cumulative movement amounts and the current image feature amount can be transmitted in time for a display image update cycle. The input device 300 displays the pseudo current image on the image display section 311 by using the initial image acquired at the start of the visual servoing, the cumulative movement amounts acquired most recently, and the current image feature amount. And the input device 300 displays the cumulative movement amounts on the movement amount display section 312 by using the cumulative movement amounts acquired most recently. As a result, during the visual servoing, the user can visually recognize the pseudo current image on the display screen at hand as if viewing the image captured by the imaging device 400 in real time. The input device 300 serving as the information processing device can display an image with which the user can easily grasp the progress status of the visual servoing.

When the operation of the robot 100 by the visual servoing is completed, a determination in step S25 in FIG. 5 becomes YES, and the control device 200 proceeds to step S26. The control device 200 notifies the input device 300 that the visual servoing has been completed, acquires a captured image (final image) at the time of completion of the visual servoing from the imaging device 400, and transmits the captured image to the input device 300 via the (I/F) 205.

When the operation of the robot 100 by the visual servoing is completed, a determination in step S16 in FIG. 4 becomes YES, and the input device 300 proceeds to step S17. The input device 300 acquires the final image from the control device 200 and displays the final image on the image display section 311. At a stage where the visual servoing has been completed, even if the final image having a large information amount is transmitted from the control device 200 to the input device 300, no problem occurs. The user can confirm the final image actually captured by the imaging device 400 on the display screen at hand at the state in which the visual servoing has been completed.

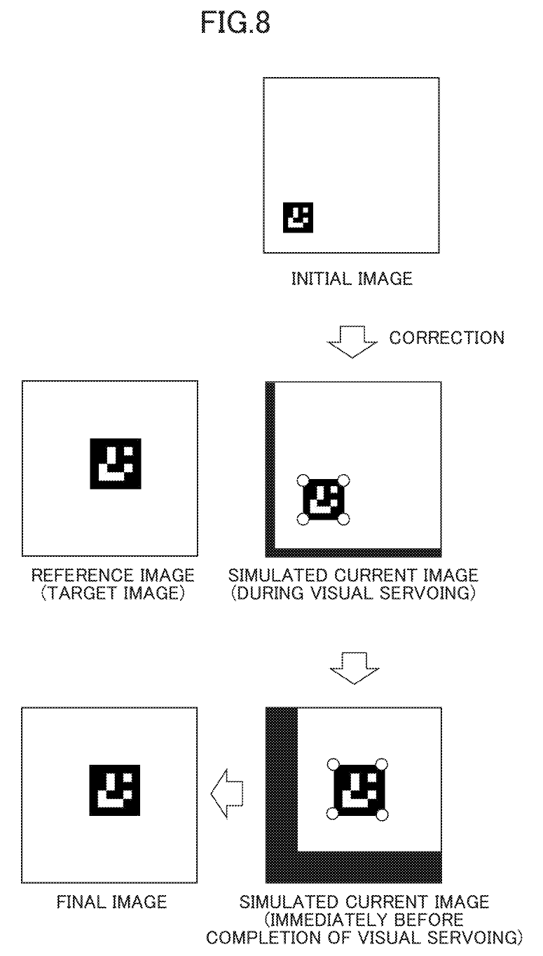

FIG. 8 illustrates an image displayed on the image display section 311 of the input device 300 at each stage of the visual servoing. The initial image displayed in step S13 at the start of the visual servoing is illustrated at the upper part of the right column in FIG. 8. The pseudo current image generated and displayed in step S15 during the visual servoing is illustrated at the middle part of the right column in FIG. 8. The pseudo current image displayed immediately before completion of the visual servoing is illustrated at the lower part of the right column in FIG. 8. The lower left column of the drawing illustrates the final image displayed when the visual servoing is completed. The user can confirm the progress status of the visual servoing on the display screen at hand. In a state in which the simulated image corresponding to the final image is displayed, when the final image is acquired, the displayed simulated image may be replaced with the acquired final image to display the final image.

The reference image (target image) captured using the imaging device 400 with the robot 100 disposed at the target position and the target pose in order to set a control target of the visual servoing is illustrated at the middle part of the left column in FIG. 8. The input device 300 can acquire the reference image (target image) from the control device 200 and store the reference image in advance, and display the reference image on the image display section 311 at each stage of the visual servoing. The reference image (target image) may be combined with the reference image feature amount and displayed. With such a configuration of the image display section 311, the user can visually compare the initial image, the pseudo current image (simulated image), the final image, and the like with the reference image (target image), and thus, can easily confirm the progress status of the visual servoing. Furthermore, a region in the simulated image that does not reflect the imaging data (valid image data) is displayed in a specific color, texture, or the like so as to be visually recognizable by the user, and in the present embodiment, such a region expands as the visual servoing progresses. The user can grasp the progress status of the visual servoing by such expansion of the region.

### Second Embodiment

A second embodiment will be described with reference to the drawings. A description of matters common to the first embodiment will be simplified or omitted. In the first embodiment, an image captured by an imaging device 400 at a visual servoing start time point is used as an initial image displayed on an image display section 311 at the start of visual servoing. Then, during the visual servoing, the initial image is subjected to image processing (for example, affine transformation or homography transformation) based on cumulative movement amounts of a robot 100, and a pseudo current image is generated and displayed.

On the other hand, in the present embodiment, the initial image to be displayed on the image display section 311 at the start of the visual servoing is generated using a reference image (target image) captured by the imaging device 400 with the robot 100 disposed at a target position and a target pose.

Also in the present embodiment, in step S22 in FIG. 5, a control device 200 similarly acquires a captured image at the visual servoing start time point from the imaging device 400 via an (I/F) 207. In the present embodiment, an image processing unit 204 obtains an image feature amount from both an image captured at an initial position and the reference image (target image) captured by the imaging device 400 with the robot 100 disposed at the target position and the target pose (second position) in advance. As described above, the image feature amount is acquired as coordinates representing a position of a characteristic element such as a side or a corner extracted from an object image included in the image. For convenience of description, a feature amount obtained from the image captured at the initial position is referred to as an initial position feature amount, and a feature amount obtained from the reference image (target image) is referred to as a reference image feature amount.

The image processing unit 204 calculates a geometric transformation matrix for transforming the reference image (target image) into the initial image based on the extracted reference image feature amount and initial position feature amount. The geometric transformation matrix is, for example, an affine transformation matrix or a homography transformation matrix. Then, the reference image (target image) is transformed using the calculated geometric transformation matrix to generate the initial image.

In step S22 of FIG. 5, the initial image generated by a method different from that of the first embodiment is transmitted to an input device 300. In step S13 of FIG. 4, the input device 300 receives the initial image generated by the control device 200 based on the reference image (target image), stores the initial image in a storage unit 301 (FIG. 2), and displays the initial image on the image display section 311. The subsequent control procedure is similar to that of the first embodiment.

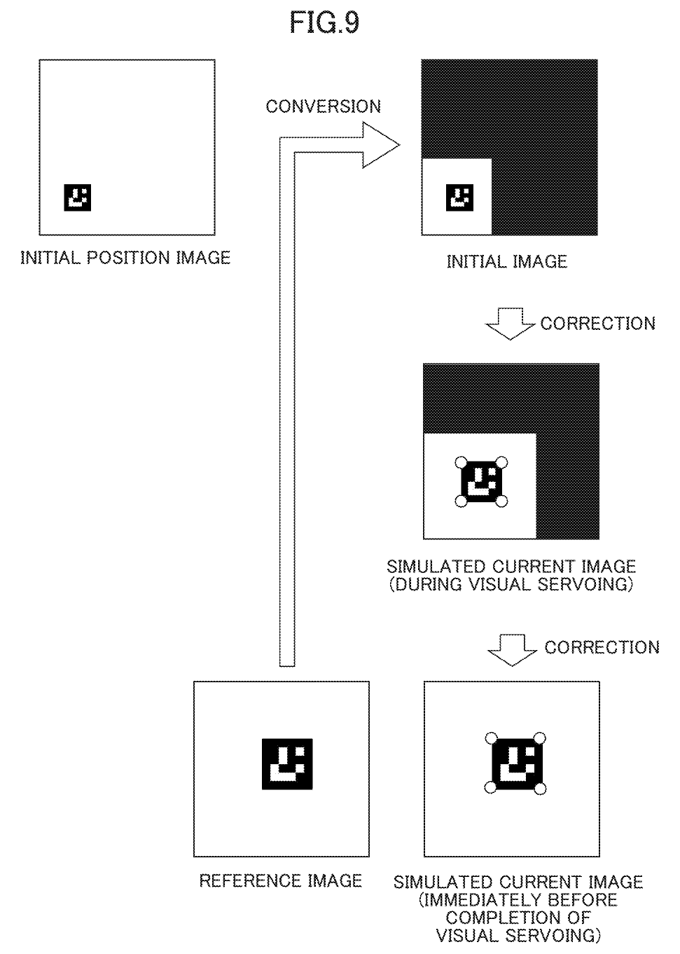

FIG. 9 illustrates an image displayed on the image display section 311 of the input device 300 at each stage of the visual servoing. An initial position image captured at the initial position at the visual servoing start time point is illustrated at the upper part of the left column in FIG. 9, and the reference image (target image) captured by the imaging device 400 with the robot 100 disposed at (reaching) the target position and the target pose is illustrated at the lower part of the left column in FIG. 9.

The initial image generated by converting the reference image is illustrated at the upper part of the right column in FIG. 9, and a region which is outside an imaging region of the reference image and in which image data does not exist appears in the initial image. In the example of FIG. 9, a region in which no valid image data exists in the initial image is displayed in black. As described above, a region where the imaging data (valid image data) is not reflected in the initial image is not limited to being displayed in black, and may be displayed in other colors, or may be displayed in a specific texture that can be visually recognized by a user, such as hatching or dots.

The pseudo current image generated and displayed in step S15 during the visual servoing is illustrated at the middle part of the right column in FIG. 9. The pseudo current image displayed immediately before completion of the visual servoing is illustrated at the lower part of the right column in FIG. 9.

The user can visually compare the initial image, the pseudo current image (simulated image), a final image, and the like with the reference image (target image), and thus, can easily confirm the progress status of the visual servoing. Furthermore, a region in the simulated image that does not reflect the imaging data (valid image data) is displayed in a specific color, texture, or the like so as to be visually recognizable by the user, and in the present embodiment, such a region is reduced as the visual servoing progresses. The user can grasp the progress status of the visual servoing by such reduction of the region.

### Third Embodiment

A third embodiment will be described with reference to the drawings. A description of matters common to the first or second embodiment will be simplified or omitted. In the first embodiment or the second embodiment, an input device 300 acquires an initial image from a control device 200 at the start of visual servoing, and generates and displays a pseudo current image (simulated image) by correcting the initial image according to cumulative movement amounts until the visual servoing is completed. However, even during visual servoing control, if a current image captured by an imaging device 400 is transmitted by thinning out frames instead of transmitting continuous frames, there may be a case where communication to the input device 300 can be performed without a large delay.

In the present embodiment, an image of an arbitrary frame is extracted from the continuous frames of the current image captured by the imaging device 400 according to a control cycle in order to perform the visual servoing and is transmitted from the control device 200 to the input device 300. When the input device 300 receives the image during the visual servoing, the input device 300 generates the pseudo current image (simulated image) by using the received current image and displays the pseudo current image thereafter.

In other words, when a robot 100 (or the imaging device 400) moves to a second current position by the visual servoing, a second current image captured by the imaging device 400 at the second current position is transmitted from the control device 200 to the input device 300.

Subsequently, the input device 300 acquires, from the control device 200, information regarding movement when the robot 100 (or the imaging device 400) further moves from the second current position by the visual servoing. Then, input device 300 generates the pseudo current image (simulated image) based on the acquired information regarding the movement and the second current image.

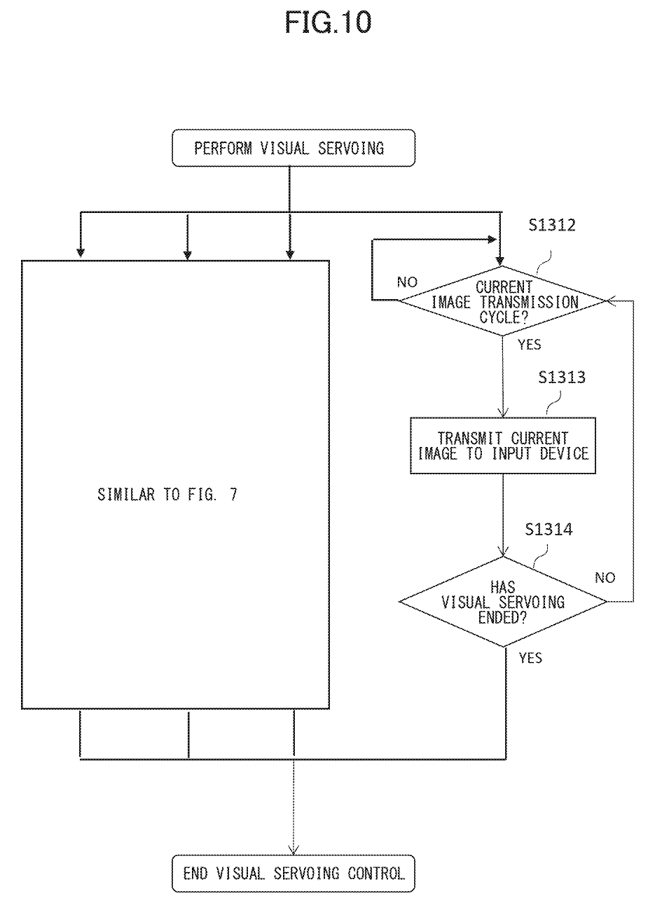

FIG. 10 is a flowchart for describing in detail processing performed by the control device 200 in steps S23 and S24 of FIG. 5 in the present embodiment. For convenience of illustration, portions common to those in FIG. 7 referred to in the description of the first embodiment are simply described.

In the present embodiment, until the visual servoing is completed, the control device 200 repeatedly performs the processing indicated by a path of steps S1312 to S1314 in parallel with three steps of processing described with reference to FIG. 7. The path of steps S1312 to S1314 indicates processing of transmitting the current image to the input device 300, and the processing is repeatedly performed at a predetermined current image transmission cycle (for example, 120 ms) as indicated in step S1312.

In a case where it is determined that the current image transmission cycle has arrived (step S1312: YES), in step S1313, a processing unit 201 transmits data of the current image of the latest frame acquired from the imaging device 400 to the input device 300 via an (I/F) 205. The transmission may be performed in synchronization with step S1310 of transmitting a cumulative control amount and a current image feature amount according to a display cycle of the input device. In this case, for example, the data of the current image of the latest frame is divided (for example, divided into four portions), and the divided portions are sequentially transmitted every 30 ms in synchronization with step S1310.

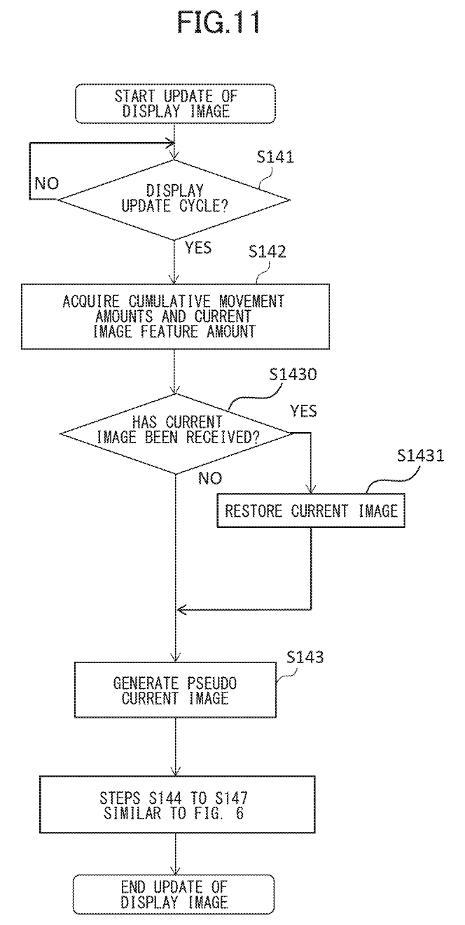

FIG. 11 is a flowchart for describing in detail processing performed by the input device 300 in steps S14 and S15 in FIG. 4. Steps S141 and S142 in FIG. 11 are similar to steps S141 and S142 in FIG. 6 described in the first embodiment. In the present embodiment, step S1430 is performed after step S142. In step S1430, it is determined whether or not the input device 300 has received the current image transmitted from the control device 200 in step S1313 in FIG. 10.

In a case where it is determined that the current image has not been received (step S1430: NO), the processing proceeds to step S143. In this case, the processing in and after step S143 is performed in a procedure similar to that in FIG. 6. In a case where the data of the current image is divided (for example, divided into four portions) and transmitted from the control device 200, it is determined in step 1430 that the current image has not been received until all the divided portions of the data of the current image are received. Therefore, during a period from the start of the reception of the divided portion to the end of the reception of all the portions of the current image, in step S143, a new pseudo current image is generated using the pseudo current image generated at the previous display update cycle and the cumulative movement amounts acquired in step S142.

In a case where all the portions of the current image divided and transmitted have been received (step S1430: YES), the processing proceeds to step S1431, and the current image of one frame is restored from the data divided and transmitted.

In this case, in subsequent step S143, the pseudo current image is generated using the restored current image. For example, in a case where the data of the current image is divided into four portions and transmitted from the control device 200 by 1/4 every 30 ms, at a time point when the current image is restored by the input device 300, a period of 30 ms × 4 = 120 ms has elapsed from a time point when the transmission of the divided portions is started. Therefore, affine transformation or homography transformation is performed on the restored current image using the cumulative movement amounts received in step S142 during the reception of the divided image data, and a movement amount during the reception of the divided image is corrected to generate the pseudo current image. The movement amount during the reception of the divided image can be obtained as a difference between the cumulative movement amounts acquired at a timing when the first divided image is received and the cumulative movement amounts acquired at a timing when the last divided image is received.

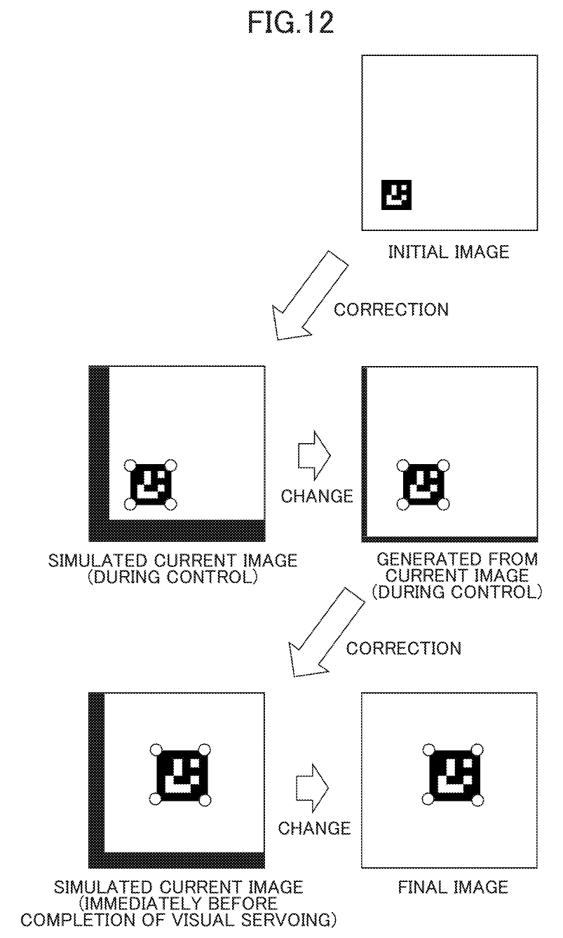

FIG. 12 illustrates an image displayed on an image display section 311 of the input device 300 at each stage of the visual servoing in the present embodiment. The initial image displayed in step S13 in FIG. 4 at the start of the visual servoing is illustrated at the upper part of the right column in FIG. 12. The pseudo current image generated and displayed in step S15 during the visual servoing, which is an image generated by correcting the initial image according to the cumulative movement amounts and a current feature amount, is illustrated at the middle part of the left column of FIG. 12.

An example in which the pseudo current image is generated and displayed using the restored current image is illustrated at the middle part of the right column of FIG. 12. The reason why “change” is illustrated instead of “correction” is that a display image is changed from the pseudo current image generated by correcting the initial image to the pseudo current image generated using the current image. The pseudo current image obtained by performing correction according to the subsequent cumulative movement amounts and current feature amount on the pseudo current image generated using the current image is illustrated at the lower part of the left column in FIG. 12, and a state immediately before completion of the visual servoing is illustrated. The final image displayed when the visual servoing is completed is illustrated at the lower part of the right column in FIG. 12.

In the first embodiment, as described with reference to FIG. 8, the pseudo current image is generated and displayed by correcting the initial image according to the cumulative movement amounts until the visual servoing is completed. Therefore, as the visual servoing progresses, as illustrated at the lower part of the right column in FIG. 8, a black portion (a portion where the image data does not exist because the portion is outside an imaging range of the initial image) increases in the pseudo current image. On the other hand, in the present embodiment, the display image is changed to the pseudo current image generated using the current image during the visual servoing. With such a change, a portion (black portion) where the image data does not exist because the portion is outside the imaging range of the imaging device in the pseudo current image is reduced. Therefore, it is possible to display a natural pseudo current image close to the actually captured current image at a user’s hand.

### Fourth Embodiment

A fourth embodiment will be described with reference to the drawings. A description of matters common to the first or second embodiment will be simplified or omitted. In the first embodiment, a pseudo current image is generated by correcting an initial image through affine transformation or homography transformation according to cumulative movement amounts. However, the pseudo current image is highly likely to include a portion (displayed in black) where image data does not exist because the portion is outside an imaging region of the initial image. In the third embodiment, a method of changing a display image to the pseudo current image generated using a current image during visual servoing to reduce a portion displayed in black is adopted.

In the present embodiment, a portion (displayed in black) where the image data does not exist in the pseudo current image is reduced by a method different from the above method. In the present embodiment, image data corresponding to a partial angle of view is cut out from an image captured by an imaging device 400, and is displayed on an image display section 311.

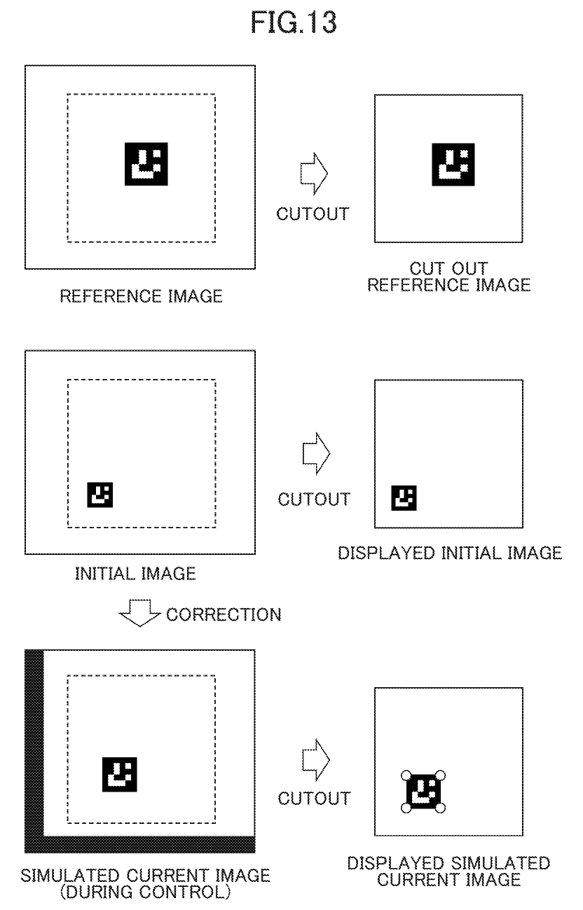

FIG. 13 illustrates the image displayed on the image display section 311 of an input device 300 at each stage of the visual servoing in the present embodiment. A reference image (target image) captured by the imaging device 400 with a robot 100 disposed at a target position and a target pose is illustrated at the upper part of the left column in FIG. 13. A solid rectangle indicates an outer edge of the captured reference image, and the image data (partial image) corresponding to the partial angle of view indicated by a dotted line is cut out and displayed on the image display section 311 of the input device 300. The reference image displayed on the image display section 311 is illustrated at the upper side of the right column in FIG. 13. As indicated by the dotted line, the angle of view for extracting the partial image is set so as to include a target.

The initial image captured by the imaging device 400 with the robot 100 disposed at an initial position and an initial pose in step S22 in FIG. 5 is illustrated at the middle part of the left column in FIG. 13, and is transmitted to the input device 300. A solid rectangle indicates an outer edge of the captured initial image, and the input device 300 cuts out the image data (partial image) corresponding to the partial angle of view indicated by a dotted line and displays the image data on the image display section 311. The initial image displayed on the image display section 311 is illustrated at the middle part of the right column in FIG. 13. As indicated by the dotted line, the angle of view for extracting the partial image is set so as to include a target.

During the visual servoing, the input device 300 acquires the cumulative movement amount and a current image feature amount from a control device 200 in step S142 in FIG. 6. Then, in step S143, the initial image illustrated at the middle part of the left column in FIG. 13 is corrected according to the cumulative movement amounts, and the pseudo current image illustrated at the lower part of the left column is generated. The input device 300 cuts out the image data (partial image) corresponding to the partial angle of view indicated by the dotted line from the generated pseudo current image, and displays the image data on the image display section 311. A state in which the cut-out pseudo current image is displayed on the image display section 311 is illustrated at the lower part of the right column in FIG. 13. As indicated by the dotted line, the angle of view for extracting the partial image is set so as to include a target.

In step S17 in FIG. 4, when a final image is acquired from the control device 200 and displayed, similarly to the reference image illustrated at the upper part of the right column in FIG. 13, the image data corresponding to the partial angle of view can be cut out from the final image and displayed.

As described above, also in the present embodiment, the pseudo current image illustrated at the lower part of the left column includes a portion (displayed in black) where the image data does not exist, as a result of the correction according to the cumulative movement amounts. However, in the present embodiment, since the image data corresponding to the partial angle of view indicated by the dotted line is cut out, combined with the current image feature amount, and displayed on the image display section 311, the display image does not include the portion (displayed in black) where the image data does not exist. According to the present embodiment, in a series of image display from the initial image to the final image through the pseudo current image, it is possible to suppress occurrence of a portion that needs to be displayed in a specific color, texture, or the like because captured image data does not exist. A user can confirm the progress status of the visual servoing on a display screen without any sense of discomfort.

### Modified Embodiment

The technology according to the present disclosure is not limited to the embodiments described above, and many modifications can be made within the technical idea of the present disclosure. For example, all or some of the different embodiments described above may be combined and implemented.

Although the input device 300 including the display screen has been exemplified as the information processing device, the information processing device according to the present disclosure may be a device that generates image data of an image with which the user can easily grasp the progress status of the visual servoing, but does not include the display unit. In this case, the information processing device can transmit the generated simulated image to a display device to display the simulated image. Furthermore, the information processing device according to the present disclosure may be a device that does not include the input unit for the user to input information regarding the visual servoing.

A control program capable of executing the information processing method using the input device 300 and a computer-readable recording medium storing the control program are also included in the embodiment.

The operation to be performed by the robot apparatus using the information processing method and the information processing device according to the embodiment is typically an operation related to manufacturing of an article, which is represented by assembly of parts, transfer, machining (including cutting, polishing, drilling, painting, bonding, welding, and the like), and cleaning. However, the present technology may also be applied to other operations of the robot apparatus.

The information processing method and the information processing device according to the embodiment can be applied to various machines and facilities such as an industrial robot, a service robot, and a processing machine operated by numerical control by a computer, in addition to production facilities.

The technology according to the present disclosure can also be implemented by processing in which a program for implementing one or more functions of the embodiments is supplied to a system or a device via a network or a storage medium, and one or more processors in a computer of the system or the device read and execute the program. The present disclosure can also be implemented by a circuit (for example, an ASIC) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-077256, filed May 7, 2025, which is hereby incorporated by reference herein in its entirety.

What is claimed is:

1. An information processing device comprising: a communication portion configured to communicate with a control device; and a processing unit,
wherein the control device is configured to control an operation of a movable unit by using an image capturable by an imaging device, and
wherein, in a case where the control device moves the movable unit from a first position to a second position, the processing unit is configured to:
acquire, from the control device, a first image corresponding to an image that is capturable by the imaging device in a state in which the movable unit is at the first position;
acquire information regarding movement while the movable unit moves from the first position to the second position; and
generate, based on the first image and the information regarding the movement, a second image corresponding to an image that is capturable by the imaging device in a state in which the movable unit is at the second position.

2. The information processing device according to claim 1, wherein the first image is a captured image captured by the imaging device in a state in which the movable unit is at the first position.

3. The information processing device according to claim 1, wherein the first image is a simulated image generated by the control device using an image that is capturable by the imaging device in a state in which the movable unit is at the second position.

4. The information processing device according to claim 1, wherein, in a case where the control device moves the movable unit from the first position to the second position via t a third position and a fourth position, the processing unit is configured to:
acquire, from the control device, a third image that is capturable by the imaging device in a case where the movable unit is at the third position; and
subsequently acquire, from the control device, further information regarding movement while the movable unit further moves from the third position to the fourth position, and generate, based on the further information and the third image, an image corresponding to a fourth image that is capturable in a case where the movable unit is at the fourth position.

5. The information processing device according to claim 1, wherein the processing unit is configured to generate the second image based on a partial image obtained by cutting out a part of the first image and the information regarding the movement.

6. The information processing device according to claim 1, wherein the second image is generated by image processing including any one of processing of translating the first image, processing of rotating the first image, and/or processing of enlarging the first image based on the information regarding the movement.

7. The information processing device according to claim 1, wherein the information regarding the movement includes information regarding cumulative movement amounts of the movable unit from the first position to the second position.

8. The information processing device according to claim 1, wherein
a target imaged by the imaging device in a case where the movable unit has reached the second position is included in the first image, and
the processing unit is configured to correct a position, a size, and/or a direction of the target in the first image based on the information regarding the movement to generate the second image.

9. The information processing device according to claim 8, wherein the information regarding the movement includes information regarding the position of the target in an image that is capturable by the imaging device.

10. The information processing device according to claim 9, wherein the information regarding the position of the target in the image includes feature amount information regarding a position of a feature element of the target.

11. The information processing device according to claim 10, wherein the processing unit is configured to:
generate a feature amount image indicating the position of the feature element based on the feature amount information; and
combine the feature amount image with the second image.

12. The information processing device according to claim 1, further comprising a display unit configured to display a reference image that is capturable by the imaging device by moving the movable unit to the second position before starting control using the image that is capturable by the imaging device.

13. The information processing device according to claim 1, further comprising a display unit configured to display a region in which image data of the first image is not reflected in a specific color or a specific texture in the second image.

14. An article manufacturing method using the information processing device according to claim 1, the article manufacturing method comprising:
performing an article manufacturing step by moving the movable unit from the first position to the second position by the control device through visual servoing while generating the second image.

15. An information processing method using an information processing device configured to communicate with a control device, the control device being configured to control an operation of a movable unit on which an imaging device is mounted by using an image that is capturable by the imaging device, the information processing method comprising in a case where the control device moves the movable unit from a first position to a second position:
acquiring, by the information processing device, a first image from the control device, the first image corresponding to an image that is capturable by the imaging device in a state in which the movable unit is at the first position
acquiring, by the information processing device, from the control device, information regarding movement while the movable unit moves from the first position to the second position; and
generating, based on the first image and the information regarding the movement and by the information processing device, a second image corresponding to an image that is capturable by the imaging device in a state in which the movable unit is at the second position.

16. A non-transitory computer-readable recording medium recording a program for causing a computer to execute the information processing method according to claim 15.

17. An input device comprising:
a processing unit configured to execute the information processing method according to claim 15; and
an input unit through which a user inputs information regarding an operation of the movable unit.

18. An article manufacturing method using the input device according to claim 17, the article manufacturing method comprising:
receiving, by the input device, information regarding the operation of the movable unit; and
performing an article manufacturing step by moving the movable unit from the first position to the second position by the control device.
